(19) United States
(12) Patent Application Publication
(10) Pub. No.: US 2023/0010362 A1
(43) Pub. Date: Jan. 12, 2023

(54) SYSTEM AND METHOD FOR DETERMINING CONTENT EFFECTIVENESS

(71) Applicant: Rally Inc., Milford, MA (US)

(72) Inventor: Lori M. Sylvia, Milford, MA (US)

(21) Appl. No.: 17/861,185

(22) Filed: Jul. 9, 2022

Related U.S. Application Data
(60) Provisional application No. 63/220,225, filed on Jul. 9, 2021.

(51) Int. Cl. G06Q 30/02; G06F 3/0482

(52) U.S. Cl. CPC G06Q 30/0245; G06F 3/0482

(57) ABSTRACT

A method of determining content effectiveness, predicting content engagement, and recommending actions related to content is carried out by a content management system. The content management and analysis system analyzes a piece of content submitted by a user, determines a desired outcome for the piece of content, determines an audience engagement for the piece of content, tracks an audience behavior for the piece of content, determines a target persona related to the piece of content, determines a likely intent of the target persona related to the piece of content, and assigns a value to the piece of content based on a content effectiveness determined from the desired outcome, the audience engagement, the audience behavior, and the target persona. A user interface can include a dashboard interface that displays one or more pieces of content and an effectiveness score for each of the one or more pieces of content.

### FIELD OF THE DISCLOSURE

The present disclosure relates to systems and method for determining the effectiveness of content.

### BACKGROUND OF THE DISCLOSURE

Many companies spend thousands or millions of dollars per year on marketing for their company including advertising and branding, as well as thousands or millions of dollars per year on recruiting for potential employees. Many companies have few ways of determining and/or predicting the effectiveness of their recruiting and/or marketing content to attract the audiences they intended. One example way of doing this is counting the number of clicks that each piece of content receives.

### SUMMARY OF THE DISCLOSURE

The present disclosure relates to a system and method for determining effectiveness of content. The method includes analyzing a piece of content that may be submitted by a user or otherwise accessed by the system, determining a desired outcome for the piece of content, determining an audience engagement for the piece of content, tracking an audience behavior for the piece of content, determining a target persona related to the piece of content, determining a likely intent of the target persona related to the piece of content, and assigning a value to the piece of content based on a content effectiveness determined from the desired or actual outcome, the audience engagement, the audience behavior, the target persona, and the likely or the actual intent of the persona. The primary value of a piece of contents is its effectiveness in creating a desired outcome, e.g., its effectiveness rating.

In the method, a piece of content can be received from the user prior to the piece of content being published. In the method, the piece of content can be received from the user after the piece of content has been published. The method can further include obtaining the piece of content prior to analyzing the piece of content. In the method, the piece of content can be obtained by an API to the channel. In the method, the piece of content can be obtained by an API to a recruiting or marketing system. In the method, the piece of content can be obtained directly from the user. In the method, the piece of content can be obtained from employees at the user's company. In the method, the piece of content can be obtained from a database. In the method, the piece of content can be obtained from a website on the Internet or other appropriate sources such as a social media platform, text/SMS, chatbot or email communication. The method can further include determining metadata, through manual entry or automated processing, related to the piece of content. Manual entry can be performed the user, or on behalf of the user by the supplier of the system, a system administrator or the user's agency/staffing firm/consultant. In the method, the metadata can be determined automatically by artificial intelligence, machine learning or a natural language processing by the content management system. In the method, the audience behavior can be tracked before the audience engagement. In the method, the audience behavior can be tracked after the audience engagement. In the method, the audience persona can be probable, desired or actual. The method can further include predicting engagement, audience persona, and outcome of the piece of content based on the user's past results and results of other users' content. The method can further include determining a likely intent of the audience persona such that the content effectiveness value is further determined from the likely intent of the audience persona. The method can further include making predictions and recommendations to the user regarding a new piece of content to achieve a desired engagement, audience persona, or outcome prior to publishing the new piece of content. In the method, a first target persona can be a candidate for a first job and a second target persona can be a customer for a first product or service. In the method, the first target persona has a first likely intent, the second target persona has a second likely intent, and further comprising a third target persona having a third likely intent and a fourth target persona having a fourth likely intent. In the method, a persona may be a candidate and a customer simultaneously, or first one and then the other.

A user interface in accordance with the present disclosure is configured to be displayed by a device having a processor and one or more memories, the user interface including a dashboard interface that displays one or more pieces of content and an effectiveness score for each of the one or more pieces of content, and a new data interface configured to allow a user to upload content and metadata via the user interface. Content can be manually uploaded by the user, or on behalf of the user by the supplier of the system, a system administrator or the user's agency/staffing firm/consultant.

In the user interface, the effectiveness score for each of the one or more pieces of content is provided as compared to past performance of the user. In the user interface, the effectiveness score for each of the one or more pieces of content is provided as compared to performance of other users having similar content and similar metadata, can be compared to performance of other users having different content and different metadata, or can be compared to performance of other users having different content and similar metadata. In the user interface, the effectiveness score for each of the one or more pieces of content includes a rating or effectiveness score of a most effective content type, publisher, channel and publishing schedule for content effectiveness.

A method according to the present disclosure includes analyzing a piece of content submitted by a user, determining a desired outcome for the piece of content, determining an audience engagement for the piece of content, determining a target persona related to the piece of content, and assigning an effectiveness score to the piece of content determined from the desired, probable and/or actual outcome, the audience engagement, the audience behavior, and the target persona.

The method can further include tracking an audience behavior for the piece of content. The method can further include determining a likely and/or actual intent of the target persona related to the piece of content.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 is a block diagram of an overall system for managing content and determining content effectiveness including a content management and analysis system, according to the present disclosure.

FIG. 2 is a diagram of a sample user interface (UI) display for the content management system, for example as a website screen display or a screen for a mobile application.

FIG. 3 is a block diagram illustrating further details of the content management system and features provided by the content management and analysis system, and specific interactions with the various channels, according to the present disclosure.

FIG. 4 is a flow diagram illustrating the flow of information from the content management system in the form of a mobile application and interaction with the various websites and databases, according to the present disclosure.

FIG. 5 is a flow chart illustrating a flow for the content management system, which for example may be carried out as the algorithm, according to the present disclosure.

FIG. 6 is a diagram of a first audience member identifier (ID) assigned to a suspect based on information gathered, according to the present disclosure.

FIG. 7 is a diagram of a second audience member identifier (ID) assigned to a suspect based on information gathered, according to the present disclosure.

FIG. 8 is a diagram illustrating one way the system can enable a user to create and categorize custom tags.

FIG. 9 is a diagram of a sample list of metadata for categorizing content.

FIGS. 10 and 11 are diagrams of a sample benchmarking report.

### DETAILED DESCRIPTION OF THE DISCLOSURE

The present disclosure describes and illustrates a system and method for determining content effectiveness in generating a desired outcome. The term “desired outcome” as used herein should be interpreted broadly to mean any desired outcome or action. A desired outcome may for example be clicks on or views of certain content, purchase of a product or service, applying for a job, purchasing stock in a company or mutual fund, taking a survey, signing a petition, voting, contacting a real estate agent, liking or following a content provider, and so on. When a desired outcome is achieved this is sometimes called a conversion, e.g., clicks or engagement with content that is converted into a desired outcome. The terms “system”, “method”, “tool”, “content management system” and “platform” are used interchangeably herein to refer to the content management and analysis system and method of the present disclosure. The term “content” as used herein refers to information with a purpose for a targeted audience. The target audience is all of the potential purchasers of a product (“customers”) or potential applicants for a job (“candidates”). The term “user” as used herein (and described in more detail hereinafter) refers to a company or individual that is a) publishing content with the purpose/intent of influencing members of the target audience (audience members) to take a desired action, such as purchasing a product or service or applying for a job (the desired outcome), and b) a user of the content management system and method described herein. The information provided in content may be text, video, audio, photos, graphics, and the like. The content may also include links (such as tracking links), QR codes and other devices that take audience members to external or internal content.

According to the system and method, a content management and analysis system, which may be in the form of a cloud-based server that manages a website or mobile application, tracks and analyzes how audience members interact with a piece of content and the ultimate actions taken by audience members after interacting with the content to determine the effectiveness of the content in achieving a desired outcome. For example, the effectiveness of a piece of content can be provided as an “effectiveness score that is determined in accordance with other techniques disclosed herein to determine content effectiveness. A desired outcome for the piece of content is determined. The desired outcome can either be provided by the user (content-provider), or the desired outcome is automatically generated by the content management system (or simply the system) based upon the analysis of the piece of content and the user of the system. The desired outcome may also be provided by a third party or a third-party system. For example, if the system is connected to the user's email system, then the system may obtain certain information about the desired outcome via the email system. The desired outcome can refer to any desired outcome of the content being published, such as an audience member purchasing a particular good or service, an audience member applying to a job posting, or other desired outcomes. The content effectiveness may also be determined based on information obtained through APIs from other recruiting and/or marketing systems and also from various channels, such as social media. The system may determine or assume the desired outcome not only based on what the content is, but also based on who is the creator of the content, what was the desired outcome of the creator's previous content, and/or where the creator is publishing the content (channel) and other factors.

An audience engagement with the piece of content is determined, which may include details about the way with which the particular audience member interacts with the particular piece of content. An audience behavior for the piece of content may be tracked for the piece of content, which may include the interaction of the particular audience member with particular content and/or a particular channel (such as a social media platform or other appropriate platform) before and/or after the engagement with the piece of content and the channels in which the interaction took place. The audience behavior may also include the actions that the audience member takes or performs prior to and/or after engaging with the piece of content and the channels and the placements or positions on the channels via which these actions were taken. The desired outcome refers to the outcome that a particular content-provider is seeking, such as someone becoming a job applicant, or someone buying a product, or someone subscribing to receive their content, or someone following the content-provider's social media channel.

A target persona is then determined that is related to the piece of content, e.g., the target persons for the piece of content. This determination may be made and entered by a user or may be determined automatically by the system. The target persona may also be determined by the system (or the user) from a third party or a third-party system. For example, if the system is connected a third party's applicant tracking system (ATS) and receives candidate emails from that other system, then the system or user may determine the target persona (such as a candidate engineering manager) from this information. Or the ATS may provide specific information about the email list that the email was sent to, for example. A likely intent of the target persona is then determined for the piece of content. A value or score is then assigned to the piece of content based on a content effectiveness determined from at least one of: the desired or actual outcome, the audience engagement, the audience behavior, the target persona, or the audience intent.

The system advantageously allows the combining or merging of multiple content-providers, such as recruiters and marketers, such that a single system or tool (for example in the form of a website or a mobile application) can be used to determine the content effectiveness for both recruiters and marketers, for example. In this manner a single company having one or more recruiters and one or more marketers can implement a single tool, the system as describe herein, to determine whether their content is most likely to reach or be consumed by an intended candidate in the case of a recruiter, or an intended customer in the case of a marketer, what content is most effective in generating desired outcomes, what day of the week and/or time of day is most effective in generating desired outcomes, and what channels and placements or positions on those channels are most effective in generating desired outcomes. The system as described herein can inform a user company on what are the most effective types of content to publish and at what times and on what channels and in which placement or position on that channel in order to reach a candidate, even if that person was previously a customer, and vice versa, or a customer of another company using the channels monitored by the system. The system described herein solves the difficulty of gathering complete and accurate information on the effectiveness of content in achieving a desired outcome when content is published on different channels, different content creators within a company are communicating with both candidates and customers with the same or similar content using the same or similar channels, and potential customers can become potential candidates and potential candidates can become potential customers. The system can likewise predict information about content, such as its effectiveness, before and after it is published.

It will be appreciated that the system described herein can perform multiple business functions for multiple users at the same time. For example, the system may perform both marketing for a marketer and recruiting for a recruiter. As described herein, the system may also perform other functions in addition to marketing and advertising. The system described herein thus provides users with the ability to implement a single platform when tasked with performing multiple functions. By eliminating the need to pay for, learn and maintain different platforms for different business functions, the system disclosed herein can create large savings in time and money for users. Moreover, by accessing multiple systems, multiple users, multiple target audiences, multiple content providers, and multiple channels, the present system is able to gather much more diverse and comprehensive data into a single data set than is possible or easily done when using multiple systems for multiple functions. Moreover, the present system enables the use of new metrics/characterizations of content, audience members, etc. to gather new data, data that is focused in the most effective or desired ways. With this improved data set, the system according to the present disclosure can provide better predictions, insights and evaluations than is possible using multiple separate systems for different purposes.

Increasingly, marketing and recruiting strategies are converging and are targeting the same or similar audiences. Creating effective content is essential to attracting those targeted audiences in both marketing and recruitment strategy. In some cases, a piece of content may be visited by an audience member that is a customer when the content-provider intended for a candidate to visit the piece of content (such as an article, job description, blog post, social media post, or the like). And vice versa, a piece of content may be visited by an audience member that is a candidate when the content-provider intended for a customer to visit the piece of content (such as a press release or marketing material for a good or service description). The system if the present investigation facilitates and takes advantage of this convergence of different business activities.

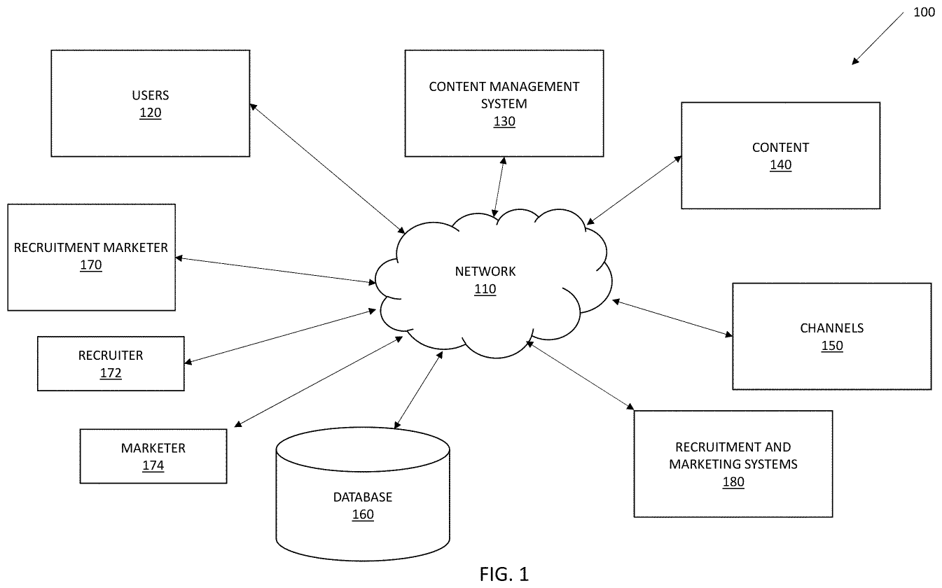

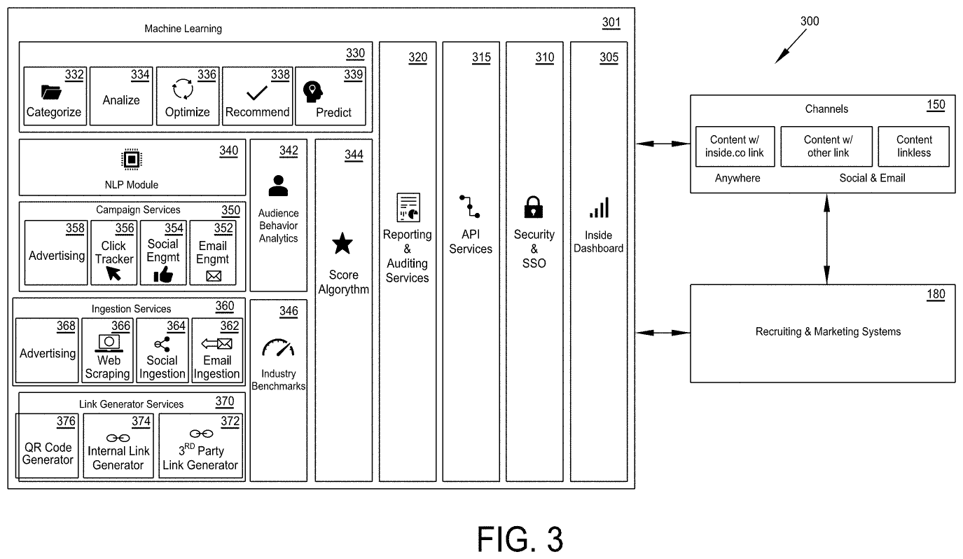

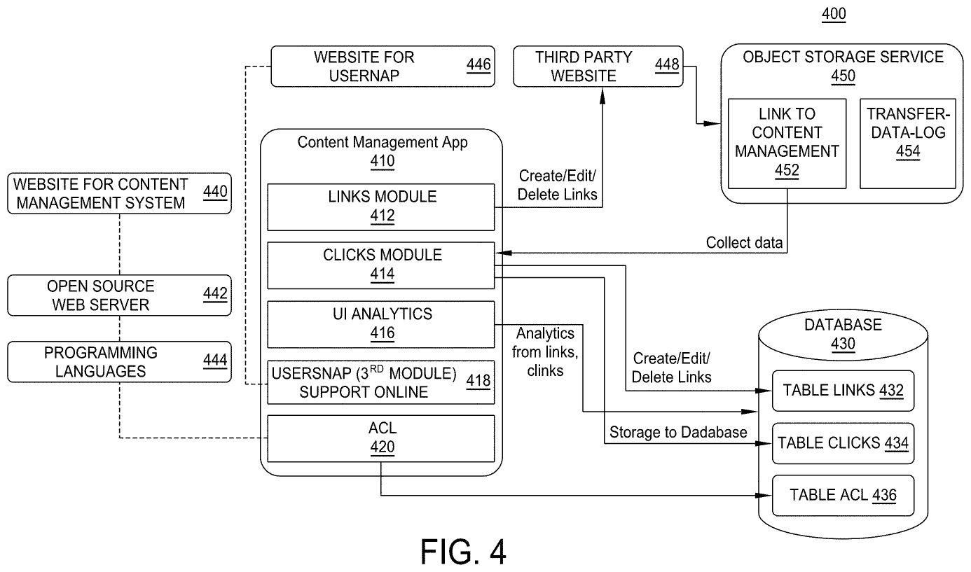

FIG. 1 is a block diagram of an overall environment for managing content and determining content effectiveness including a content management and analysis system, according to the present disclosure. The overall environment 100 allows users 120 to determine the effectiveness of the content 140 they are providing to a content management and analysis system 130. The users 120 can communicate with the content management system 130 via a network 110 which may be any appropriate network communication. The network can be any appropriate network communication such as the Internet, a local area network (LAN), a wide area network (WAN), Wi-Fi, or other networks as will be appreciated. The system 130 refers to one or more hardware components, one or more software components, or a combination or hardware and software components such as a device having memory and one or more processors configured to carry out instructions, and may be in the form of an application downloaded on (or downloadable onto) a mobile device or a web-based (or cloud-based) application accessible by any appropriate device, such as a computer, a mobile phone, a website, or an application downloaded on a desktop computer. The content 140 is provided via the network 110 over various channels 150 which may include social media channels or other means of conveying the content, including emails, blog posts, websites, and other channels or platform(s) for communication. The content 140 may be content that was previously created and that has already been published, content that was previously created but has not yet been published, or content planned to be published, or recommendations for suggested content based upon user interaction with the content management and analysis system 130, as will be appreciated in light of the present disclosure. The content 140 may also include content that the user has shared regarding content prepared by other individuals or companies, which may be referred to as “content curation” in which the content is not created or published by the user, but rather content they have shared to attract an audience as well as content that has been shared to provide information to their existing audience. A database 160 may be used to store data pertinent to the content management and analysis system 130, which may be in the form of one or more cloud-based or local data storages, as shown in greater detail in FIGS. 3-4, and as will be apparent to one ordinarily skilled in the art and the techniques of the present disclosure.

It will be appreciated that the term “user” or “users” as shown and described herein is intended to refer to users of the content management system platform, as well as employees of the user's company, for example a recruitment marketer, talent manager, recruiter, marketer, sales manager, or any other employee that provides or generates content related to a particular company, or that monitors, measures, analyzes or reports on content effectiveness. The user may also be a third-party entity or individual, such as a contractor, agency, or vender that provides goods, services, recruitment, content or marketing materials, or any other outside non-employee that assists a user company with content generation or strategy, or monitoring its effectiveness. It will be apparent in light of the present disclosure that the user can also be a content creator for themselves individually not affiliated with a company. In general, the term user includes any individual or entity that is acting on behalf of a company or themselves, or more generally any entity or individual that creates, publishes, or shares, content or monitors, measures, analyzes or reports on the content's effectiveness. The user also refers to a content curator who is responsible for sharing rather than creating or publishing content.

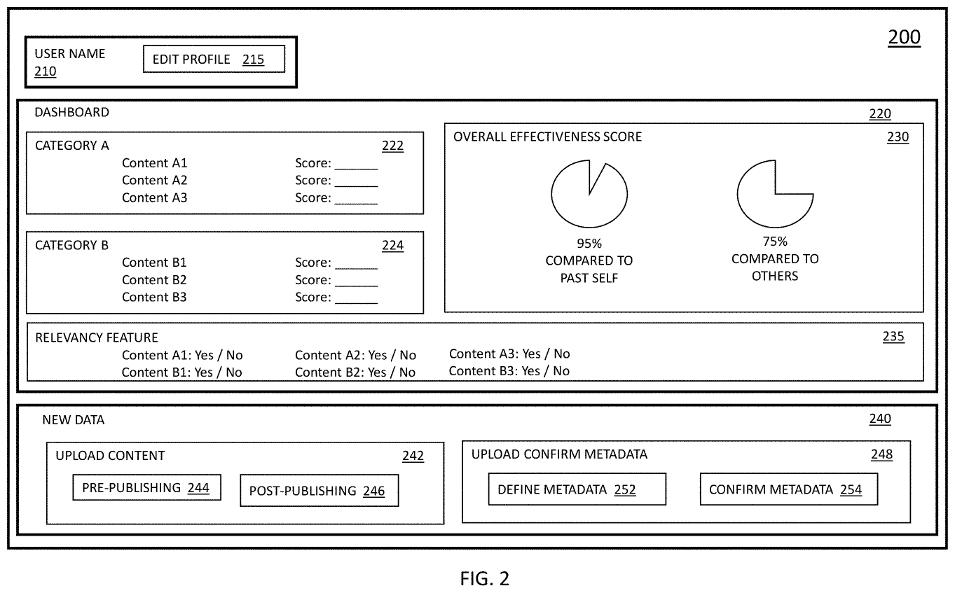

The environment 100 also includes a recruitment marketer 170 which may be used to describe a new entity or manager of content that incorporates recruiting and marketing into a single content-management system. The content management system 130 can interface with the recruitment marketer 170 as well as a recruiter 172, a marketer 174, and/or existing recruitment and marketing systems 180. Although shown and described with respect to the advantage of combining recruiting with marketing, this will likewise be applicable with the combination of any other sources for content generation and analysis. One example implementation of the various interactions between the content management system 130, the content 140, the channels, the recruitment marketer 170, and the recruiting and marketing systems 180 is shown in FIG. 3, and an example user interface display is shown in FIG. 2. The recruiter 172 and the marketer 174 are also examples of “users” as content providers in accordance with the present disclosure.

It should be apparent in light of the present disclosure that although shown and described primarily with respect to a recruiter seeking candidates and a marketer seeking customers, this could also apply to any different pieces of content, such as a single company that provides goods and services and wants to differentiate and/or combine their efforts for goods and services into a single marketer, rather than one marketer that focuses on goods and another marketer that focuses on services, as well as other content that targets a specific product, customer, candidate, or job type, among other criteria. Likewise, in accordance with the techniques of the present disclosure, a single system or application can be used for individuals and/or companies seeking to not only attract customers in the sense of purchasers of their product, but also customer as used herein refers to partners, suppliers, investors, or any other entity interested in a particular company and the goods or services they are providing, as well as followers or subscribers that may only be interested in following a person and/or receiving content related to that particular person or company.

FIG. 2 is a diagram of a sample user interface (UI) display 200 for the content management system, for example as a website screen display or a screen for a mobile application. The display 200 includes a user name interface button 210 which can display a username or other information for a user, and also have an edit profile button 215 which allows a user to edit their profile information. The display further includes a dashboard portion 220 which displays a plurality of content pieces, which may for example be arranged into categories 222 and 224, with each category having an effectiveness score for each piece of content. An overall effectiveness score 230 can also be provided which can include a comparison of the current piece(s) of content to past piece(s) of content, illustrated as a 95% score, as well as a comparison to other users, illustrated as a 75% score.

As will be appreciated in light of the present disclosure, the content management system and associated interface may provide a “relevancy feature” 235 that analyses different forms of content, such as social media, videos, texts, graphics, links, tags, ads, websites or webpages, emails, etc., and determines whether or not particular content is relevant to an effectiveness score for a particular desired outcome. The relevance of a piece of content may be automatically determined or flagged by the system using machine learning, AI, NLP, tracking links, or otherwise tracking when a visit to specific content leads to a desired outcome or a higher or lower effectiveness score. The system may also allow a particular user to determine which content is (or is not) relevant to a particular effectiveness score. For example, a particular post on a social media platform may be flagged by the system as relevant to a job posting related to a job, when it is in fact not relevant, or not flagged as relevant, when in fact it is relevant, and the system allows for a relevance determination/flag to be manually removed from or added to consideration for the content effectiveness score for a particular desired outcome. In this case, each piece of content A1, A2, A3, B1, B2, B3 is provided with an option for the user to categorize whether the content is relevant “yes” or not relevant “no” (as shown in relevancy feature 235) to indicate for the system whether the particular piece of content is relevant to the category in the interface 222, 224. In this way incorrect determinations of relevance by the system can be prevented or corrected.

For many companies, the social media channels are shared by different users. For example, recruitment, marketing and corporate communications, with each trying to reach a different audience through the same social media channels. A company may have a LinkedIn page, a Facebook page, etc. A company may have multiple LinkedIn pages to communicate with their different audiences separately. As a result, there is much cross over and redundancy in audiences reached. The system disclosed herein enables a user to create a tracking link in a social media post. The system can then detect the link (using Natural Language Processing) and determine, for example, that the post is relevant to recruiting candidates, for example, because of how the user categorized that link. The system also enables a user to manually categorize published social posts, whether use a tracking link or no link at all. As a result, no matter who internally was the author of that post/content, the system is informed or can determine which posts are likely to be relevant to candidates or other intended target audiences. The system can therefore only analyze posts that are relevant to the intended target audience, so that content that is not relevant to the target audience doesn't get factored into the content effectiveness score. The system can determine which one of a company's different intended audiences a social post is intended to reach. It doesn't matter who was the creator of the content. It does not matter if the content was created by a specific user or some other team at the company, or if it is social content that was curated and shared to the company's audience.

In some embodiments, social content that is being analyzed by the system may include a tracking link which was generated by the system or was generated by a third-party system. The system, using machine learning, AI and/or NLP, can detect the link in the social content and automatically determine the relevance of this social content and how to analyze it. As such, the user does not necessarily need to manually enter content metadata or indicate relevance manually, but is able to do so if desired, the interface 200 also provides an option to enter/upload and present new data or content 240. The upload content interface 242 includes a pre-publishing button 244 and a post-publishing button 246 for uploading content either pre-publishing or post-publishing. There is also the option to define or confirm metadata 248 via the define metadata button 252 or the confirm metadata button 254. The system may automatically ingest the user's content that they already published, so that the user does not need upload this content. Content that users have already published, such as on their social media channels, email, websites, text/SMS can be ingested and automatically viewed, tracked and analyzed by the system.

As will be appreciated in light of the present disclosure, the define metadata button is for a user to define metadata pertinent to their content, and the confirm metadata button allows a user to confirm metadata that has been generated by the system that is pertinent to the content they have presented or requested to be analyzed by the content management system. Metadata and content may be defined and uploaded by a user, or on behalf of the user by the application supplier, servicer, administrator, an agency, staffing firm or consultant. The metadata and tasks associated therewith will be shown and described in greater detail herein.

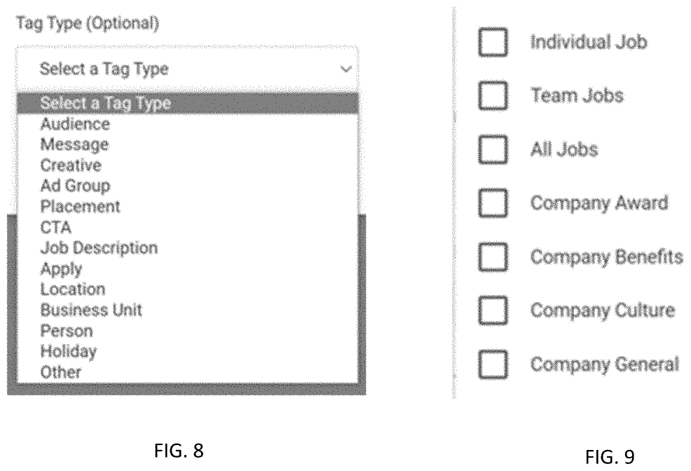

FIGS. 8 and 9 are diagrams illustrating possible metadata that may be selected by the user to characterize content. FIG. 8 is illustrative of a list with which a user may generate custom characterizations (or tags) for tagging content as being related to one of an audience, message, creative, ad group, placement, call to action (CTA), job description, apply, location, business unit, person, holiday, and so on. FIG. 9 is an illustrative list that can be contained in the system with which a user may designate (or categorize) content as being related to one or more of an individual job, team jobs, all jobs, company award, company culture, company general, and so on. All sorts of lists may be employed by the system according to the present disclosure to identify, tag, categorize or characterize content, for example intended outcome for the content, location of the content, date of publication of the content, date of an event, various requirements for a job, or to identify or characterize audience members, for example, engineer, senior engineer, musician, consumer, or to identify or characterize content providers or channels, and so on. This characterization can be called tags that are associated with/tagged to specific content as metadata. As described herein, the selection of the characterizations for each piece of content may be done automatically by the system and/or manually by the user or on behalf of the user.

Although not explicitly shown, the interface may also include details about suggested, predicted, or curated content that the content management system has generated via machine learning, artificial intelligence, natural language proceeding, or other techniques in accordance with the present disclosure. Alternatively, curated content may be provided separate from the interface, for example in the form of an email with a document or another format of choice.

In addition, although not explicitly shown, each individual content piece that is tracked with the content management system, can be provided with different views of the effectiveness score based on a channel type (like Facebook) or a type of content (like career advice) or an audience persona (like experienced engineering managers, law firm paralegals graduating from university, a new purchaser of goods, a repeat purchaser of goods, and other personas), as well as provide an overall effectiveness score as a user and then as a team and then as a company. There may also be different views of the effectiveness scores for specific content for different users, such as a view for a recruiter and a different view for a marketer. Views may also be provided that display effectiveness scores for multiple users at time. For example, if specific content was intended to attract recruiting, sales and marketing, a view can show the content for each of recruiter users, sales users and marketing users simultaneously.

Different views of the effectiveness score may also be provided based on whether the content is organic (free) or paid content, clicks versus conversions, or other attributes of content such as whether the content is a location, or a message, or a business unit. A paid content effectiveness score can be very useful. By comparing or benchmarking the effectiveness of paid content verses free or organic content in generating clicks by the intended audience or in creating conversions of clicks into desired results (or simply termed a “conversion”), a user can determine if paid content is worth the cost. Alternatively, a user may learn that the free organic content is ineffective and paid content is by comparison very effective and thereby justify the cost of paid content or for increasing spending on paid content or vice versa.

Further, although not shown, the display 200 can also provide suggested content for the user or suggestions for maximizing effectiveness of the content that the users are creating or sharing, or that other team members at the company are creating and/or sharing, or that other users of the content management and analysis system are creating or sharing, or that entities outside the user company are creating or sharing. For example, benchmarks can be created and shared as part of a “community benchmarks” feature.

FIG. 3 is a block diagram illustrating still further details of the content management system, according to the present disclosure. The content management and analysis system 301 in FIG. 3 can be the same as, or substantially similar to, the content management system 130 shown in FIG. 1. The content management and analysis system is shown in still greater detail in FIG. 3 and illustrating the various services and components in greater detail. The content can be received from a recruiting and marketing system 180, or from content 140 directly provided from the user (see FIG. 1), or from any one of various channels 150, or in some cases from the recruitment marketer 170 or marketer 174 (see FIG. 1). The channels 150 can, for example, provide content with a link (generated by the content management system or a third-party entity), content with another (for example independent third party) link, or content that does not include a link. Each of these pieces of content can be via any appropriate channel including but not limited to social media, email, podcasts, websites, advertising and the like. Some content has links, and others do not have links. The system may categorize linked and linkless content in the same way or differently, and analyze them accordingly as described herein.

The content management and analysis system 301 includes a dashboard 305, a security & SSO component 310 to provide security for the content management system, an API (Application Programming Interface) services component 315 to provide for interaction and engagement with APIs for other platforms, and reporting and auditing services 320 for performing reporting and auditing services for the content management and analysis system 301. An API is essentially a connection between computers or between computer programs, and is more specifically a type of software interface that offers a service to other pieces of software. It allows other pieces of software to have access to certain information that the platform associated with the software interface has access to itself.

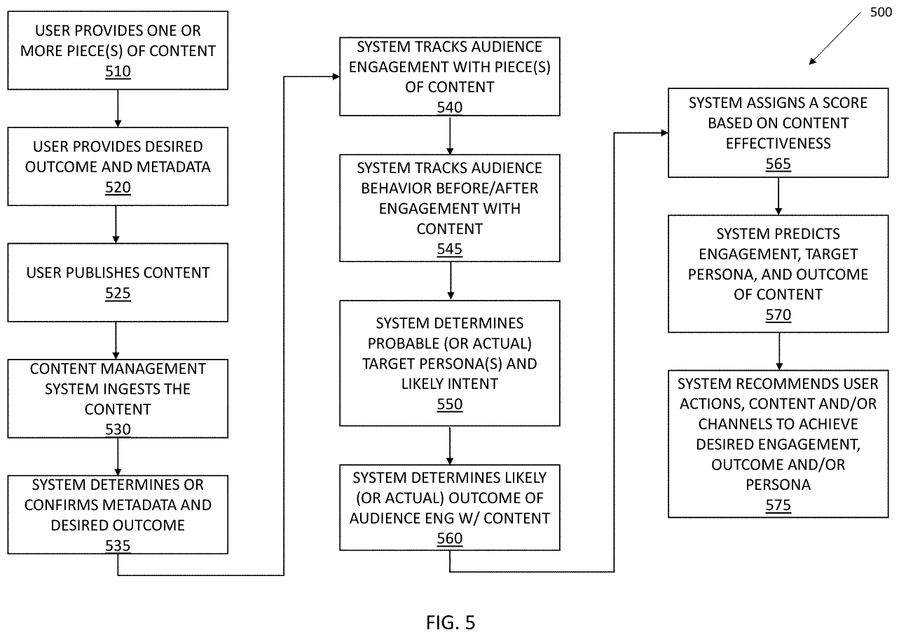

The system 301 includes a machine learning and/or artificial intelligence component 330 that is configured to determine metadata and other information pertinent to the content that is provided by users and/or recruitment marketers and/or marketers and/or any other content providers. The content management system includes a machine learning component 330 which allows for the metadata described herein to be automatically generated using machine learning and a natural language processing (NLP) component 340. When the user is a marketer, the metadata for a customer persona may, for example, be one or more of whether they have budget, authority and need to buy a product. When the user is a recruiter, the metadata for a job candidate persona may include, for example, one or more of the candidate's job functions, job level, years of experience, whether they are looking for job, current employment status, or any other relevant or desired candidate attribute. The combination of those can be considered a candidate persona, for example engineering managers with more than 5 years of experience, and can also include a customer persona, for example, a homeowner in a specific city. In some cases, the candidate persona may be the same person as a customer persona, but it is desirable to identify when the person is acting as one persona versus the other, rather than treating them as one single person. The machine learning and/or artificial intelligence component 330 can include a categorize component 332, analyze component 334, an optimize component 336, a recommend component 338, and a predict component 339. Each of the components are described in greater detail with respect to FIG. 5 and the method 500. For example, the categorize component can correspond to block 535, the optimize component can correspond to block 535, the recommend component can correspond to block 575, and the predict component can correspond to block 570. These are purely example correlations and the components may correspond to the blocks noted or to any other blocks within the process, as will be appreciated in light of the present disclosure.

The dashboard and reports component 305 can generate a user interface display similar to that shown in FIG. 2, or may include additional or fewer elements, as will be appreciated in light of the present disclosure.

The content management system 301 can implement audience behavior analytics 342, as will be appreciated in light of the method described in greater detail and shown in FIG. 5, based on the audience member past or future interaction, for example with recruiting and marketing systems 180. The score algorithm 344 can be, for example, carried out according to the method 500 in FIG. 5. The effectiveness score provided as a result of the score algorithm 344 can illustrate the effectiveness of the piece of content (or multiple pieces of content) that a user has provided to the content management system, that has been analyzed by the content management system, or that has been generated as suggested content by the content management system. For example, the effectiveness score can be provided as an “overall effectiveness score” 230 as shown in FIG. 2. The content can be generated or suggestions for content can be provided by or for the user, for example by writing or creating the content based on what has been previously established as having a high content effectiveness score, for example using machine learning and/or artificial intelligence.

The content management system 301 includes a campaign services component 350 which includes email engagement component 352, a social engagement component 354, a click tracker component 356, and an advertising component 358, as well as ingestion services 360 that include an email ingestion component 362, a social ingestion component 364, a web scraping component 366, and an advertising component 368. Each of the ingestion services 360 scours or obtains content that is to be analyzed by the content management and analysis system. With respect to the incoming content, this can be in the form of emails, in which case an email ingestion component 362 receives and ingests the email communication, social media ingested at social media ingestion component 364, and link generator component 370. The email content can be received at email ingestion component 362, and is provide to an email engagement component 352 to manage and analyze engagement with the email content. The content can be analyzed according to the techniques of the present disclosure. The social media content can be received at social ingestion component 364, and is provided to a social engagement component 354 to manage and analyze engagement with the social media content. Although social and email are explicitly shown and described, any format or platform for ingesting and analyzing content may be implemented in accordance with the techniques of the present disclosure. Advertising or a paid component can be analyzed with regard to, for example, the number of clicks/engagements generated or its effectiveness in generating a desired outcome.

The system 301 also includes link generator services 370 which may include a third-party link generator component 372 as well as an internal link generator 374 and a QR code generator component 376. The QR code may be used for tracking. A link generator component 370 can be implemented by the content management system 301 which may generate links for content and can be managed by the content management system itself or an independent third party, which for example can track the number of clicks, social media engagement metrics, and other data associated with a particular piece of content.

FIG. 4 is a flow diagram 400 illustrating the flow of information from the content management system in the form of a mobile application 410 and illustrating the interaction with the various websites and databases, according to the present disclosure. The mobile content management application 410 includes a links module or component 412, a clicks module or component 414, a user interface (UI) analytics module or component 416, an online support component 418, and an Access Control List (ACL) 420. The links component 412 allows a user to create, duplicate, edit or delete links to content, which for example may be created using a third-party link creation website 448, or an internal link generation component within the content management system. The click logs can then be stored by the third party into an object storage service 450 or other appropriate database or memory for data storage. The object storage service 450 stores objects and data through a web service interface and can, for example, be AWS S3 provided by Amazon®. The object storage service 450 includes a link to content management 452 as well as a transfer-data-log 454. The link to content management 452 allows the content management application 410 to collect data from the link creation by the clicks module or component 414. The clicks component 414 also can provide the ability to create, duplicate, edit, or delete links that are managed by a database 430 in a table of links 432. The information regarding the number of clicks related to the links can be stored in the database 430 as a table of clicks 434. The ACL 420 can be stored in the database 430 as a table ACL 436. The ACL 420 is a list that mandates how the content management system determines which features a free user has access to versus features that are provided to users of the various different paid plans.

Analytics from the UI analytics component 416 can include information from the links and the clicks, which can be also provided to the database 430 to be stored appropriately. The online support component 418 allows access to a third-party tool that allows users to provide feedback and request support regarding their experience with the content management application 410 and to provide user notification messages, such as to inform users about new features. The content management application 410 also interfaces with various programming language(s) 444 such as Python3 or Django and open-source web server(s) 442, such as Apache, to interface with the website for content management system 440.

FIG. 5 is a flow chart illustrating a flow for the content management system to generate content effectiveness scores and perform other machine learning and/or artificial intelligence (AI) tasks, which for example may be carried out as the algorithm (344 in FIG. 3), and in accordance with the techniques of the present disclosure. The method 500 commences at block 510 where a user provides one or more pieces of content to be analyzed and/or managed by the content management system (for example content management system 130 in FIG. 1 or 301 in FIG. 3). This content is provided to the content management system either pre- or post-publishing by the user. At block 520, the user provides a desired outcome for the piece of content and can optionally also provide metadata at block 520. If a user provides content, the system may automatically calculate or determine and apply metadata. Some or all of the metadata may be determined by algorithms. The user or other service provider can then confirm or correct the metadata based on the published content, or manually add additional desired metadata. The user may be any type of user, for example, user 120, recruiter, marketer 170 and the system may be used for multiple purposes, for example it can be used as both a recruiting system and marketing system(s) at the same time 180 in FIG. 1. It will be appreciated that the user can be any user that is a content creator or content provider having a purpose or some sort of intended outcome. The user can also be someone who is responsible for analytics, reporting or management and requires access to the data. The user need not be an individual or entity acting to attract an audience for a job or a company, but can be any content provider, content creator or someone who needs access to the data. By determining the most effective channels for specific content, the content management and analysis system enables content to be published on behalf of users to the most effective channels at the most effective times. By determining the most effective content for specific channels to reach desired audiences, the system enables users to publish the most effective content on the most effective channels at the most effective times with the greatest probability to achieving their intended outcome. For example, the social media channel LinkedIn®, the content can be published to their profile. The metadata can be determined by the content management and analysis system using machine learning or obtained via API from another system, as opposed to being manually provided by the user. The desired outcome in some cases may be automatically determined by a system (for example the machine learning 330 in FIG. 3 or via API from another system) instead of manually provided by the user. For example, the desired outcome and/or metadata can be determined based on the pure substance of the content, the audience engagement with the content, and/or other information obtained by the content management system, as will be appreciated in light of the present disclosure. At block 525, the content is published or shared to the appropriate channel, which may occur either before or after block 520. At bock 530, the content management system ingests the content. This can be accomplished, for example, by an email ingestion component 362, a social media ingestion component 364, or a web scraping component 366 to ingest the content via the appropriate component which may be a set of hardware or software components or a combination thereof that are configured to carry out the necessary steps to perform the task. Content that the user uploads to be ingested into the system at block 530 may include tracking links and QR codes or may not include links and QR codes. This other external content is not ingested into the system. By including the tracking links (or other connecting devices) as part of the ingested content, the audience can link to the other content and their interactions with this other content can be tracked by the system for analysis and reporting as described herein. The content management system can also ingest the content via API from a third-party system, such as Google®. At block 535, the system determines (or confirms) metadata and the desired outcome, which can again occur before or after publishing the content. In the case where the metadata is provided by the user, the system confirms the metadata, and in the case where the machine learning determines the metadata, this is determined at block 535, as well as the desired outcome. The desired outcome can likewise be provided by the user or determined by the system using machine learning and/or natural language processing, or the desired outcome can be provided via API from other systems or another channel.

At block 540, the system tracks audience engagement of one or more audience members with the piece(s) of content. There are numerous ways of tracking audience engagement by an audience member with a piece of content, including tracking a number of clicks, social media engagement metrics, obtaining other information about a particular audience member from other third-party APIs, from tracking other data by generating and providing a customized link with tracking data, obtaining information from other content publishing systems or channels, tracking what content was viewed prior to purchasing a product or applying for a job (or not making a purchase or applying), or tracking completion of forms such as applying for a job. The term engagement as used herein may refer to the number of clicks, the number of impressions, views, visits, shares, reactions, and comments, among other trackable engagements or media engagement metrics with a piece of content. At block 545, the system can also (or optionally in some cases) track the audience behavior of one or more audience member(s) before and/or after engaging with the particular piece of content. This can be accomplished by the user interaction with the system itself or by obtaining information through other APIs such as the user interaction with other platforms or channels before and/or after the interaction with the particular piece of content. For example, if the piece of content is published on a particular website, that website's API can be accessed to determine what actions the audience member performed before interacting with the piece of content and also (or instead of) the actions performed after interacting with the piece of content.

At block 550, the system determines the probable (or actual) target persona(s) and likely intent of each target personas(s). This refers to the content-viewers that are the target persona(s) of the piece of content and what their likely intent was (i.e., whether they intended to be a customer or a candidate or both; or whether they intended to be a service-purchaser or a goods-purchaser or both). In some cases, the system may determine the persona only or the intent only and not both are required. At block 560, the system determines the likely (or actual) outcome of the audience engagement with the piece of content. The likely outcome of the audience engagement can be accomplished by the machine learning and/or NPL components of the content management system. In some cases, the user may manually provide the data or information regarding the actual outcome or via an API to another system or channel. At block 565, the system assigns a score or a value for the piece of content (or multiple pieces of content) based on content effectiveness. As described herein, a user can manually determine which piece(s) of content are relevant or socially relevant to a particular desired outcome. For example, one piece of content may be determined by the system to be relevant to a particular desired outcome, however the content may not in fact be relevant, and the user may manually select (or de-select) that content as being relevant to the content effectiveness score for a particular outcome. The relevancy can also be determined automatically using machine learning, natural language processing, or artificial intelligence to determine content that is relevant to a particular desired outcome. In some cases, the users may not be allowed to manually discard certain content, but instead will have to categorize content and/or provide metadata related to the content. The content may be filtered out by the content management system with certain categories. Some examples of content that a user might want to discard includes a user announces on a social media platform that she is engaged or married (not relevant to work); a company announces that their next investor call takes place on a certain date; or a company sends an email communication to its customers about maintenance downtime. These are all examples of content that may not be included in the content efficiency score.

The content effectiveness can be compared to past performance or compared to other users, at their company or other companies, having similar or different content, metadata, and intent (see, for example, scores 230 in FIG. 2). The score can be provided as a percentage score, a pie chart, a bar graph, a line graph, color-coded scoring (with green being best, yellow being moderate, and red being worst), a letter-graded or letter-coded system (such as A, B, C, D, or F with A being best and F being worst), and any other appropriate scoring scheme.

The system can also provide additional features at blocks 570 and block 575 beyond providing a content effectiveness score or value. At block 570, the system is able to predict the engagement, audience persona(s), and outcome of the content before or after publishing, based on the user's past results and results of the other users and/or other content. At block 575, the system is able to recommend user actions, content, and/or channels to achieve the desired engagement, audience persona(s) and outcome before publishing.

It will be appreciated that the blocks of the process 500 are shown as occurring in an order, however the individual blocks may be performed in any order other than that shown in FIG. 5, and it is also possible that some blocks may occur simultaneously or in an order different than that shown in FIG. 5. This is only intended to provide an example order of the process and not to limit the order in which the process must be performed. For example, the system may track audience behavior first (block 545) and then track audience engagement with a piece of content (block 540), with many other variations and options available.

The system can also use information such as time stamp from user data (which may be obtained from APIs of various channels or from other recruiting and marketing systems) to determine the best time of day to publish certain content for optimum effectiveness in obtaining the desired outcome. Many other factors and variables can be selected by the user or by the system to achieve the best possible effectiveness score for a piece of content or a group of content and increase the chance of obtaining the desired outcome. In some instances, each piece of content can be displayed with an effectiveness score or value, and then also provide different views of their effectiveness score based on the channel type (such as Facebook® or LinkedIn®) or a type of content (such as career advice) or an audience persona (like engineering managers) or an attribute of the content/metadata (such as message or location), as well as provide an overall effectiveness score as a user and then as a team and then as a company.

In accordance with the techniques of the present disclosure, a member of the audience can be provided with a number or designation number (an audience member ID number, or simply an ID) in order to track and characterize the audience member. By tracking the behavior of an ID, the system can determine the persona of this particular ID/audience member. For example, the system can determine the type(s) of audience member this ID is or likely is (customer, candidate, etc.) and/or the intent(s) (or likely intent(s)) of this ID (they intend to apply for a job, buy a product, view a certain type of content, etc.). The different types of possible audience members are virtually endless. An audience member or intended audience members can be actual, intended or possible purchasers or subscribers (customers), job candidates, investors, voters, survey takers, content viewers, members of a club, members of a sports team, and so on.

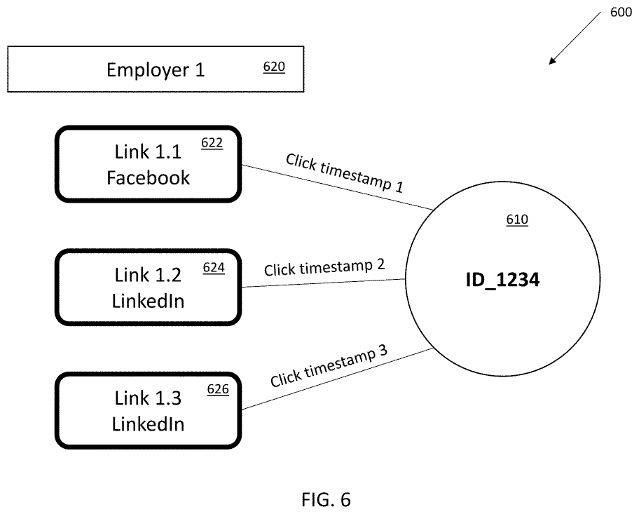

FIG. 6 is a diagram of a first ID audience member identifier ID assigned to a suspect member of the audience based on information gathered, according to the present disclosure ID. Note that each single person/ID may have multiple personas and multiple intents. For example, one particular person (audience member) could simultaneously be a candidate for one type of job, a candidate for a second type of job, a customer for a particular good, or a customer for a particular service provided by the same or different companies. Thus, a particular persona for an audience member can be assigned an ID to track their behavior. Different behavior can be used to represent one characteristic of one persona. This is much more customizable than tracking only by IP address or other technique. The system may also track other attributes or characteristics of an ID, such as through APIs from other channels, platforms, and systems related to the ID. The location, type of device, operating system, internet browser type and version, and other information related to an ID, such as demographic information, firmographic information, content engaged, and candidate hiring status and customer product purchases can be tracked, analyzed and scored/evaluated. This technique can also be combined with a known IP address (when known) to further enhance the features of the system.

As will be appreciated in light of the present disclosure, multiple personas can exist for a single ID, device or user. In this case, the ID “ID_1234” is assigned at 610 and can have the information identifying or suspecting that it is a human, within the United States, in a particular state (for example, Massachusetts), and within a particular city or town (e.g., Boston), type of device (e.g., laptop or desktop or tablet or mobile phone), operating system (e.g., Windows® or Mac®) as well as version number, internet browser type (such as Google Chrome or Microsoft Edge) as well as version number. Other information can be obtained from various APIs such as Employer Information 620, Channel information 622 illustrating the link and the channel type the ID was using along with timestamp of the click, channel information 624 illustrating the link and the channel type along with timestamp of the click, and channel information 626 illustrating the link and the channel type along with timestamp of the click. The persona and information associated therewith can be used in accordance with the techniques herein to determine effectiveness of content. By identifying and searching for patterns, common themes can be identified to more accurately provide a content effectiveness score for the particular piece of content and different forms of the content. For example, is the content more effective as text, graphics or video, or as a link to one of these forms of content? Is the content more effective as an email or SMS message or notice? Is the content more effective when it is at the beginning or end (top or bottom) of an email, text or video, or the second position in a carousel ad? Meaning the system can be informative regarding where to publish, as well as regarding what time of post, channel and form of content is most effective. What wording, music, type of music, colors, style of mood of content is more effective? All these things and more can be tracked, evaluated and benchmarked one against the other to determine specifically what content is the most effective in generating a desired outcome.

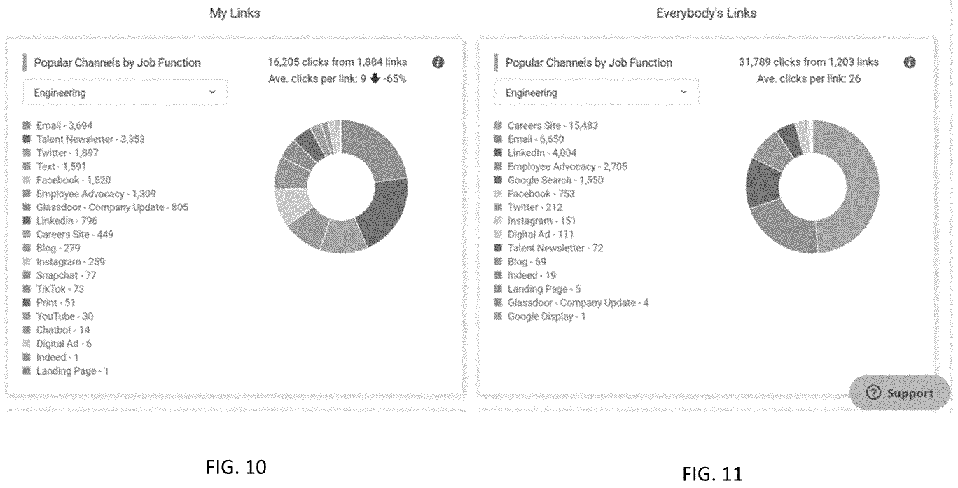

FIGS. 10 and 11 are diagrams illustrating what a benchmark report generated by the system according to the present disclosure may look like. The illustrative benchmark report shows the audience engagement with specific content (tracked by number of clicks on links) in the most used channels in the case of, for example, one of content engaged by audience members that are Engineers (or are likely engineers) who are looking (or are likely to be looking) to purchase a product or service (engineering customers), or content engaged by audience members that are Engineers looking for (or are likely looking for) an engineering position/job (engineering job candidates), or for engagement with content intended for engineering customers or candidates. FIG. 10 shows the most popular channels in which the user's content was engaged with according to content clicks and FIG. 11 shows the most popular channels in which everybody's (all system users') content was engaged with according to content clicks. FIGS. 10 and 11 may be displayed side by side to enable a user to easily benchmark the engagement of their content to determine what the best channels for this content may be. For example, it is readily apparent in this example that the user's content is receiving much more engagement by the intended audience in the email and talent newsletter channels. Whereas the content by everyone is receiving much more engagement by the intended audience in the careers site channel (their company websites career pages) and email channel. It will be appreciated that a great variety of benchmark reports may be created. For example, benchmark reports can be created that benchmark the level of engagement with (effectiveness of) different content by target audience personas (for example music purchasers/customers) for determining which content is most effective in generating engagement with this target audience/persona, or conversion rates (for example percent of engagements that result in a purchase or job application) of different types of content to determine which content is most effective in generating the desired outcome, and so on. Different benchmark reports can be set in the system by the system supplier or may be manually generated by the user, or may be automatically generated by the system based on data analysis.

Another example is the ability to track which content pieces on which channels are engaged with, and in which order. The intent or type of an audience persona can thus become clear, e.g., whether the persona is a candidate or a customer or both, and it can be determined (through machine learning, AI, or NLP) which companies or employers and jobs or products/services that the audience persona might be interested in simultaneously, or over time. It can be identified when the type of a persona or ID changes from one type to another, such as from a candidate to a customer. In this way, the system can determine present persona and intention.

In addition, for each ID, a probability score can be provided (which is separate from the content effectiveness score described herein). For example, an 80% probability that the ID is associated with an audience member having certain features, interests, and/or engagements with certain pieces of content by one or more users, channels or platforms. Or for example, a probability that a particular ID is in fact a human and not an artificial or computer-generated entity.

Each ID may also be assigned an engagement score based on how much they are engaging with the content of the user, or other users at the same or different company, or engaging with certain types of content across users. Each ID may further be assigned a value score, to identify whether the ID is of high-value to the user, meaning are they a good target. For example, an ID may be a good target if they are a real person and they are a repeat customer or likely to become a job candidate. Data relating to IDs may also be looked at and analyzed in the aggregate to determine and predict various things. For example, the system can determine how much of their audience is a good target, how many candidates are likely to apply for a job, how many are likely to transition from one type of persona to another, etc.

When an audience member clicks on a users' content, or otherwise tries to view a webpage, oftentimes the IP address is not available and/or it is desirable to not store this information, so it is not possible using standard techniques to ascertain precisely “who” the audience member is and therefore what their intention may be when they engaged with the content. In this case, using non personally identifiable information, each “click” is assigned an ID and then using information about engagement and behavior, a probability score is determined that a person has been identified and what their persona(s) and intent(s) may be. Over time, when it is suspected that the same ID is clicking, more engagement and behavior characteristics are being analyzed, patterns can then be recognized (either manually or by machine learning or AI) and the probability scores for that ID can either be increased or decreased accordingly. IDs can then be aggregated to tell users (based on probability analysis), for example, how many unique people are clicking/engaging with their content; and how much of their audience overlaps between social and digital channels, and so on. By analyzing the data, the system can also inform the user on what percentage of their audience is highly engaged to barely engaged at all with their content. As well as which IDs are “low value” because they don't take further action to achieve the desired outcome, and which IDs are high value because they do. The system can also inform users about which content and/or channels lead to higher engaged by IDs and which attract lower engaged IDs. The system can also provide conversion tracking and analytics. For example, example the system can track which content influences an ID to become a customer and buy goods/services or become a candidate by applying for a job at the company or both. In this way the system can determine the “actual” outcome of the content. The system can also track whether an ID, after engaging with a piece of content, purchases a good or service from the company or applies for a job at the company.” This is incredibly useful information for users and companies as it may be that they are unnecessarily providing their content in multiple formats or on multiple channels when only one format or channel is actually needed to achieve the desired outcome. The system can also inform users on how much of their audience is comprised of candidates and customers, or both, (or other persona types), and how many customers are likely to become candidates and vice versa. The system can also inform users on which or how many IDs have already or are likely to become a purchasing customer or job candidate, and if they are repeat customers or candidates (or other persona types).

Through integration with the user's recruiting and/or marketing systems, or companies' recruitment and/or marketing systems, specifically systems that capture and store identities of candidates and/or customers, the system can gather more information to create better evaluations, scores or even reveal new information, such as new or different content or channels that are being effectively used by other systems or companies. By so integrating the system with other systems, the system may also exchange information about a particular ID, for example, via API within these other systems. Although the identity of that person will still not be known (or may be known in some cases), the systems can confirm that the ID is in fact a real person. The identity of the person may be known or unknown to the content management system, or may be known to other systems in communication with the content management system. Those systems can then be provided with information about how that individual has engaged with the content before and after becoming a known person and before and after taking a desired action. This information is used to determine the audience persona(s) and intent(s) and to track the outcome.

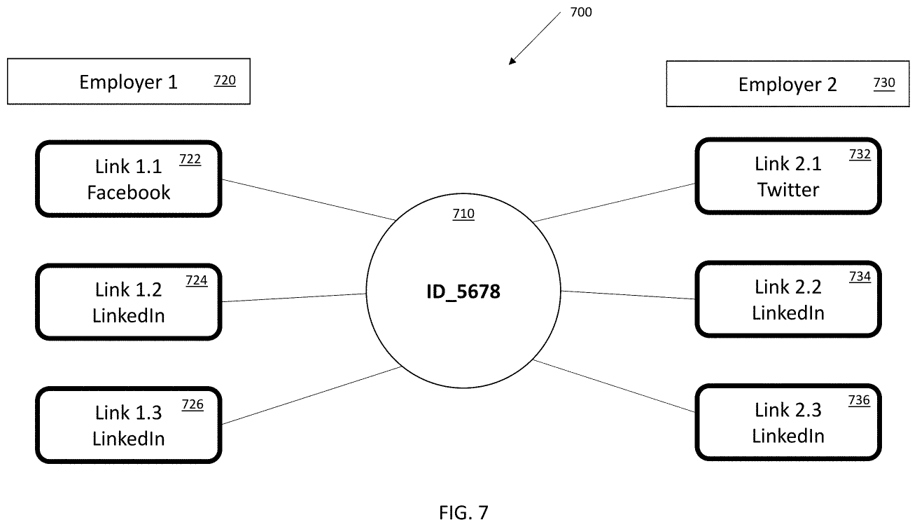

FIG. 7 is a diagram of a second audience member identifier (ID) assigned to a suspect based on information gathered, according to the present disclosure. In this case, the ID “ID_5678” is assigned at 710 and can have the information identifying that it is a human, within the United States, in a particular state (for example, New Hampshire), and within a particular city or town (e.g., Concord), type of device (e.g., laptop or desktop or tablet or mobile phone), operating system (e.g., Windows® or Mac®) as well as version number, internet browser type (such as Google Chrome or Microsoft Edge) as well as version number. Other information can be obtained from various APIs such as Employer Information 720, Channel information 722 illustrating the link and the channel type which can also include a timestamp of the click, channel information 724 illustrating the link and the channel type which can also include a timestamp of the click, and channel information 726 illustrating the link and the channel type which can also include a timestamp of the click. Additional information shown associated with this ID 710 is a second employer 730, additional channel information 732 illustrating the link and channel type which can also include a timestamp of the click, channel information 734 illustrating the link and the channel type which can also include a timestamp of the click, and also channel information 736 illustrating the link and the channel type which can also include a timestamp of the click. The audience member and information associated therewith can be used in accordance with the techniques herein to determine effectiveness of content. Furthermore, a database of IDs that are attracted to certain pieces or types of content can be maintained and provided back to the providers of content to determine the actual audience members and/or candidate IDs that are accessing particular pieces of content. For example, the information can be stored and appropriately sorted to determine that certain pieces of content successfully target or actually attract a certain geographic region or age group.

Each individual content piece that is tracked with the content management system (whether in a platform, mobile application, or web-based browser) can be displayed by the dashboard (e.g., 220 in FIG. 2, or 305 in FIG. 3) and given an effectiveness score, and then provided with different views of their effectiveness score based on one or more of a type of content engaged (like career advice), attributes of the content engaged (like messaging, creative, call to action, and other ways of categorizing and describing the content), an audience persona (like engineering managers), or channel used (like Facebook® or LinkedIn®), the system can also provide an overall effectiveness score for a user, for a team, or for a company, as will be appreciated in light of the present disclosure.

Various methods of ranking, scoring and valuing content, audience members and channels may be employed by the system according to the present disclosure are described herein. It will be appreciated that numerous other ways of scoring, ranking or valuing content, audience members and channels may be implemented by the system of the present disclosure. The following are some illustrative examples of scoring and ranking that may be performed by the system. A candidate's or other persona's engagement with a user's content may be provided a score based on one or more of various metrics such as gross number or percentage of total clicks, views, impressions, reach, shares, comments, and conversions (actual desired outcomes directly from engaging with specific content). These scores may be based on different types of content and/or channels. The system may rank the performance of user's content against other users from the same company and/or different companies. Content and channels may be ranked according to what performs the best and worst (for each user and for users in aggregate). Content may be scored on its effectiveness to achieve the desired outcome. For example, assigning a score or value to a piece of content based on the content's effectiveness determined from the desired outcome, the audience engagement, the audience behavior, the target persona and the intent of the target persona related to the piece of content. Different pieces of content having like attributes may be ranked by their effectiveness. A users may be scored based on their effectiveness in using content to achieve the desired outcome, e.g., an employer Brand Engagement Score. People (candidate/customer IDs) who click on a user's content may be scored based on their probability of being a human, whether they are the audience intended, or on their value to the user.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of and “consisting only of are to be construed in a limitative sense.

The computer readable medium or software as described herein can be a data storage device, or unit such as a magnetic disk, magneto-optical disk, an optical disk, or a flash drive. Further, it will be appreciated that the term “memory” or “data storage” as used herein is intended to include various types of suitable data storage media, whether permanent or temporary, such as transitory electronic memories, non-transitory computer-readable medium and/or computer-writable medium.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A method comprising:
analyzing a piece of content submitted by a user;
determining a desired outcome for the piece of content;
determining an audience engagement for the piece of content;
tracking an audience behavior for the piece of content;
determining a target persona related to the piece of content;
determining an intent of the target persona related to the piece of content; and
assigning a value to the piece of content based on a content effectiveness determined from the desired outcome, the audience engagement, the audience behavior, the target persona and the intent of the target persona related to the piece of content.

2. The method of claim 1, wherein the piece of content is received from the user prior to the piece of content being published.

3. The method of claim 1, wherein the piece of content is received from the user after the piece of content has been published.

4. The method of claim 3, further comprising obtaining the piece of content prior to analyzing the piece of content.

5. The method of claim 4, wherein the piece of content is obtained by an API to the channel or an API from another system.

6. The method of claim 4, wherein the piece of content is obtained directly from the user.

7. The method of claim 4, wherein the piece of content is obtained from a storage medium, the storage medium comprising at least one of: a database, a cloud-based memory, or a blob storage.

8. The method of claim 1, further comprising determining content metadata, through manual entry or automated processing, related to the piece of content.

9. The method of claim 8, wherein the metadata is determined automatically by machine learning, artificial intelligence, or a natural language processing by the content management system.

10. The method of claim 1, wherein the audience behavior is tracked before the audience engagement and/or after the audience engagement.

11. The method of claim 1, wherein the target persona is probable or actual.

12. The method of claim 1, further comprising:
predicting engagement, audience persona, and outcome of the piece of content based on the user's past results and results of other user's content.

13. The method of claim 12 further comprising:
determining an intent of the audience persona such that the value based on the content effectiveness is further determined from the intent of the audience persona.

14. The method of claim 1, further comprising:
making recommendations to the user regarding a new piece of content to achieve a desired engagement, audience persona, and outcome prior to publishing the new piece of content.

15. The method of claim 1, wherein a first target persona is a candidate for a first job and a second target persona is a customer for a first product or service.

16. The method of claim 15, wherein the first target persona has a first likely intent, the second target persona has a second likely intent, and further comprising a third target persona having a third likely intent and a fourth target persona having a fourth likely intent.

17. The method of claim 1, further comprising: assigning a candidate identifier (ID) to an audience member so as to associate the audience engagement, the audience behavior, and the desired outcome for the audience member with the ID.

18. The method of claim 17, wherein the ID is used to determine the target persona and the intent for each audience member.

19. The method of claim 1, further comprising determining a relevancy for the piece of content by artificial intelligence or machine learning.

20. A user interface configured to be displayed by a device having a processor and one or more memories, the user interface comprising:
a dashboard interface that displays one or more pieces of content and an effectiveness score for each of the one or more pieces of content; and
a new data interface configured to allow a user to upload content and metadata via the user interface.

21. The user interface of claim 20, wherein the effectiveness score for each of the one or more pieces of content is provided as compared to past performance of the user.

22. The user interface of claim 20, wherein the effectiveness score for each of the one or more pieces of content is provided as compared to performance of other users having similar content and similar metadata.

23. The user interface of claim 20, wherein the effectiveness score for each of the one or more pieces of content is provided as compared to performance of other users having different content and different metadata.

24. The user interface of claim 20, herein the effectiveness score for each of the one or more pieces of content is provided as compared to performance of other users having different content and similar metadata.

25. The user interface of claim 20, wherein the effectiveness score for each of the one or more pieces of content includes an effectiveness score relating to the effectiveness of a channel for specific content.

26. The user interface of claim 20, wherein the dashboard interface includes a relevancy feature that allows a user to confirm or deny relevancy of each of the one or more pieces of content with respect to a desired outcome.

27. The user interface of claim 20, wherein the relevancy of each of the one or more pieces of content is determined by artificial intelligence or machine learning coupled to the user interface.

28. A method comprising:
analyzing a piece of content;
determining a desired outcome for the piece of content;
determining an audience engagement for the piece of content;
determining a target persona related to the piece of content; and
assigning a value to the piece of content based on a content effectiveness determined from the desired outcome, the audience engagement, the audience behavior, and the target persona.

29. The method of claim 28, further comprising tracking an audience behavior for the piece of content.

30. The method of claim 28, further comprising determining a likely intent of the target persona related to the piece of content.
